(19) United States
(12) Patent Application Publication
(10) Pub. No.: US 2022/0220759 A1
(43) Pub. Date: Jul. 14, 2022

(54) POOL CLEANING DEVICE

(71) Applicant: AQUA ELITE LLC, Brielle, NJ (US)

(72) Inventor: Gordon F. Adams, III, Point Pleasant, NJ (US)

(73) Assignee: AQUA ELITE LLC, BRIELLE, NJ (US)

(21) Appl. No.: 17/573,839

(22) Filed: Jan. 12, 2022

Related U.S. Application Data
(60) Provisional application No. 63/136,544, filed on Jan. 12, 2021.

(51) Int. Cl. E04H 4/12; E04H 4/14

(52) U.S. Cl. CPC E04H 4/1272; C02F 2103/42; E04H 4/14

(57) ABSTRACT

Described is a pool monitoring device that monitors variables such as water level, water pH, and water temperature. Further, the pool monitoring device facilitates removal of the skimmer basket of a pool for cleaning/maintenance.

### CLAIM OF PRIORITY

This application claims priority to U.S. Application No. 63/136,544 filed on Jan. 12, 2021, the entire disclosure of which is incorporated herein by reference.

### FIELD OF THE EMBODIMENTS

The field of the present invention and its embodiments relate to pool monitoring devices that monitor variables such as water level, water pH, and water temperature. Further, the pool monitoring device facilitates removal of the skimmer basket of a pool for cleaning/maintenance.

### BACKGROUND OF THE EMBODIMENTS

Removing floating debris and monitoring water conditions of a swimming pool is a necessary maintenance task. Water is typically drawn from the pool via an aperture in the wall of the pool and into a filtration device called a skimmer, which traps debris that is removed from the pool in this manner. Contained in the skimmer is a basket that filters the water carrying the debris, thus trapping the debris and preventing the debris from passing through to a pump. Thus, cleaning of the skimmer basket is a necessary and regular task for maintaining proper swimming pool water circulation and clarity.

Most skimmers include a lid or cover, which is normally mounted flush or slightly raised with respect to the pool deck to avoid creating a tripping hazard. As a result, a skimmer lid or cover is usually difficult to remove. A lid may include a hole at its center, or a plurality of holes located off center, closer to the edges of the lid. The removal of the lid may require a person to insert their fingers through the holes to grab the lid. In addition, most skimmer baskets include some type of a handle, which can be used to lift the basket from within the skimmer well. A user is required to bend over, reach into the water and/or debris, through the undesirable contents of the basket, to manually grab the handle of the basket.

Devices have been designed to assist with the abovementioned maintenance tasks, the majority of which include tools having a single rod and/or a single hook used to engage and lift portions of a skimmer. However, these devices do not provide an effective means for removing a skimmer well lid, in addition to providing for monitoring of water conditions of a pool.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention and its embodiments relate to a pool monitoring device. The pool monitoring device is multifaceted and can carry on a number of functions related to maintaining a pool. The pool monitoring device can be used to take the place of a lid of a conventional skimmer basket. This allows for the lid to provide some functionality to a user and assist a user in removing the pool monitoring device and further removing the skimmer basket for cleaning as needed. The pool cleaning device further has a tube or tubular member that extends downwards toward the surface of the water. This tubular member houses a number of components related to monitoring one or more conditions of the pool water. At a terminal end of the tubular member, the pool monitoring device has at least one hook to be used to pull up on and remove the skimmer basket for cleaning and inspection. This prevent a user from having to bend over and reach down to pick up the basket which may be cumbersome or have refuse collected therein that is best not touched.

In an embodiment of the present invention, there is a pool monitoring device having a support plate; a tubular member coupled to the support plate; at least one hook coupled to the tubular member; and at least one water based sensor configured to sense at least one property of water.

In another embodiment of the present invention there is a pool monitoring device having a support plate having a display thereon; a tubular member having a first end and a second end, the tubular member being coupled to the support plate at the first end; at least one hook coupled to the second end of the tubular member, wherein the at least one hooks has a plurality of tabs extending therefrom; and at least one water-based sensor configured to sense at least one property of water.

In yet another embodiment of the present invention there is a pool monitoring device having a support plate with a display thereon, wherein the support plate has at least one notch along a periphery of the support plate; a tubular member having a first end and a second end, the tubular member being coupled to the support plate at the first end; an end cap coupled to the second end of the tubular member; two hooks coupled to the second end of the tubular member. wherein the two hooks have a plurality of tabs extending from an outer surface therefrom; and at least one water-based sensor configured to sense at least one property of water, wherein the at least one water-based sensor is a pH sensor, total dissolved solids sensor, and a temperature sensor.

It is an object of the present invention to provide a pool monitoring device that replaces a conventional pool skimmer lid.

It is an object of the present invention to provide a pool monitoring device that is lightweight and easy to use.

It is an object of the present invention to provide a pool monitoring device that monitors one or more conditions of the pool water.

It is an object of the present invention to provide a pool monitoring device that aids in the lifting and removal of a pool skimmer basket.

It is an object of the present invention to provide a pool monitoring device that can alert a user to inspect a pool due to one or more detected pool water conditions.

It is an object of the present invention to provide a pool monitoring device that is configured to withstand the natural elements.

### BRIEF DESCRIPTION OF THE DRAWINGS

FIG. 1 shows a side view of an embodiment of the present invention.

FIG. 2 shows a top view of an embodiment of the present invention.

FIG. 3 shows a sectional side view of an embodiment of the present invention in use.

FIG. 4 shows a sectional side view of an embodiment of the present invention being used to remove a pool skimmer basket.

FIG. 5A shows a top view of an additional support plate.

FIG. 5B shows a bottom view of an additional support plate.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

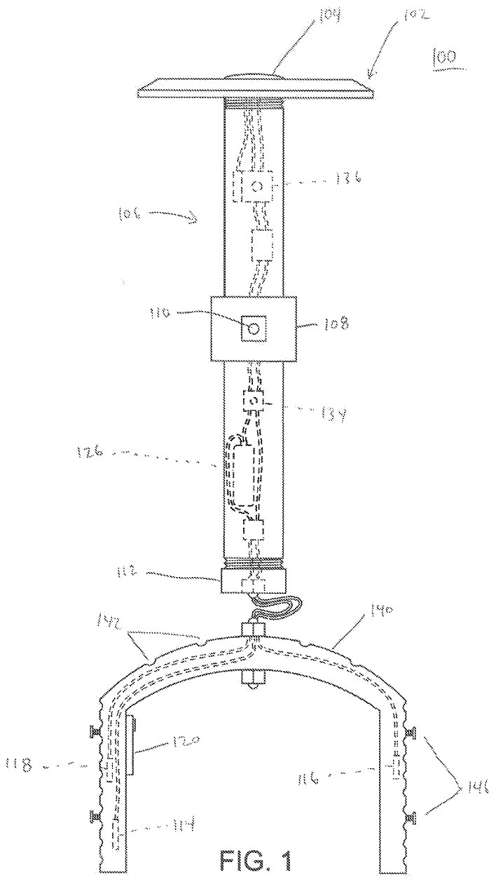

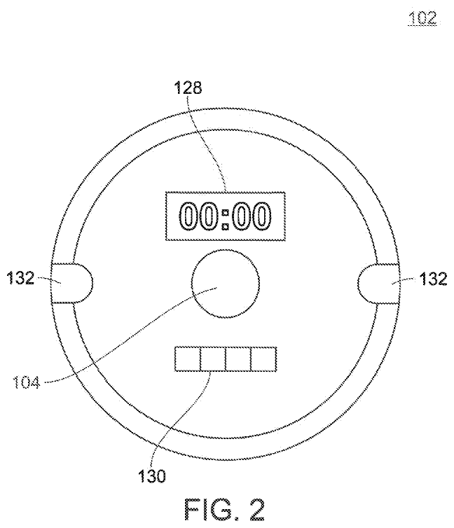

Referring now to FIGS. 1 and 2, there is a pool monitoring device 100 comprising generally of a support plate 102, and a tubular member 106. Other components/structures include but may not be limited to LED(s) 104, magnet(s) 110, float 108, high water magnet 136, power source 126, low water magnet 134, pH sensor 114, end cap 112, total dissolved solids (TDS) sensor 116, tabs 122, corrosion anode 120, U-shaped member 140, holes or apertures 142, display 128, notch(es) 132, solar panel/array 130, and temperature sensor 118.

The support plate 102 comprises a generally circular plate designed to replace the cover of a pool skimmer. Accordingly, the exact dimensions and shape may be varied to match the opening to a particular pool skimmer. Along a periphery of the support plate 102 is at least one and preferably at least two notches 132. The notches 132 are sections of the support plate 102 configured to assist a user in removing the support plate 102 from the opening or access to the skimmer basket. The notches 132 may take varying shapes and dimensions. In use, a user would preferably use at least one finger at each notch 132 and apply a force directed towards the center of the support plate 102. With a sufficient force being supplied, the user then should be able to easily free and lift the support plate 102 from the access.

In one embodiment, further integrated with the support plate 102 is a solar panel 130, a display 128, and at least one light emitting device such as a light emitting diode (LED) 104. The display 128 may be virtually any type of display (liquid crystal, light emitting diode, etc.) configured to display information associated with the pool monitoring device 100 or the pool itself. The display 128 may be configurable to commonly display certain types of information and may otherwise permit a user to customize or otherwise modify the manner in which information is displayed via the display 128. Information to be displayed may be, for example, information collected by one or more of the sensors associated with the pool monitoring device 100.

The solar panel 130 may act as a primary or secondary power source for the pool monitoring device 100. The solar panel 130 may be a conventional collection of solar cells configured to utilize light and store energy therefrom for operating the pool monitoring device. In some embodiments, one may be able to select whether the solar panel 130 is the primary or secondary power source.

A light emitting device such as a light emitting diode (LED) 104 may further be positioned upon or in the support plate 102. The LED 104 can be configured to communicate (via color, on/off state, variable flashing pattern) the status of one or more parameters associated with the pool monitoring device 100. For example, each sensor may cause, as an alert, the LED 104 to emit light and each sensor may be assigned its own color of light such that a user can readily differentiate and diagnose a potential issue with the pool monitoring device 100 or the pool/pool water/etc. In some embodiments, a message may be transmitted by the pool monitoring device 100 to an electronic device, such as a cellular telephone, to alert an owner of the phone of a particular status of the pool monitoring device 100 and/or pool.

As shown in FIG. 1, the tubular member 106 is positioned substantially perpendicular to the support plate 102. The tubular member 106 is at least partially hollow and/or has cavities to house components therein in a watertight seal. Such components may include the power source 126, printed circuit board and wiring (not shown), high water magnet 136, and low water magnet 134. The internal components, particularly the power source 126 may be accessed via the end cap 112 positioned at an end of the tubular member 106 opposite the support plate 102. The end cap 112 may be attached via conventional means such as threading, friction fit, etc. along with an O-ring or other watertight seal capabilities.

The high water magnet 136 and low water magnet 134 may be positionable and “locked” into varying fixed positions along a length of the tubular member 106. This allows for the float 108 to move upwards and downwards slidably along the length of the tubular member 106. When the float 108 and the float magnet 110 encounter the high water magnet 136 or low water magnet 134 a circuit is completed sending a signal to the LED 104 or a secondary electronic device to alert a user that the water level of the pool is improper. By allowing the magnets to be repositionable, this can account for varying user preferences as well as differences between pool installations.

The sensors of the pool monitoring device 100 may include a pH sensor 114, a TDS sensor 116, and a temperature sensor 118. Each of these sensors are coupled to the LED 104 and collect information pertinent to the pool water environment in which the sensor resides. Each of these sensors may be housed together or separately within a housing or portion of the U-shaped member 140. The pH sensor is configured to monitor a pH of the pool water and alert a user as to a pH level that is outside of the set parameters whether set by the manufacturer or the user of the pool monitoring device 100. The TDS sensor 116 measures the amount of total dissolved solids in the pool water environment and is coupled to the LED 104. This sensor allows a user to understand if the number of dissolved solids reaches an unsafe or undesirable threshold. Lastly, the temperature sensor 118 measures the temperature of the pool water. The temperature sensor 118 is coupled to the LED 104 and is capable of assisting in generating an alert if the pool water becomes too warm thereby allowing harmful bacteria or other organisms to flourish in the water thereby posing a hazard to those who may swim in the pool.

In some embodiments, a corrosion anode 120 is further disposed along the U-shaped member 140. This corrosion anode 120 may be periodically replaced as needed and helps to prevent the corrosion of pool metals (e.g. ladders) that are in constant contact with the pool water. In at least one embodiment, the corrosion anode 120 is a zinc anode. This corrosion anode 120 may be further housed with the sensors described above.

As described above, there is preferably protruding from an end of the tubular member 106 a U-shaped member 140 (as shown in FIG. 1), that houses a number of the components described herein such as the temperature sensor, pH sensor, TDS sensor, corrosion anode, and the like or some combination thereof. This U-shaped member may have a plurality of holes or apertures 142 in a surface of the U-shaped member. This allows for fluid communication between an outside environment and an interior of the U-shaped member. This further allows for the sensors contained therein to have access to the pool water environment in order to sense properties of the pool water. Further, the U-shaped member 140 may have connecting screws 146 designed to interact with the skimmer basket as shown in the FIGS.

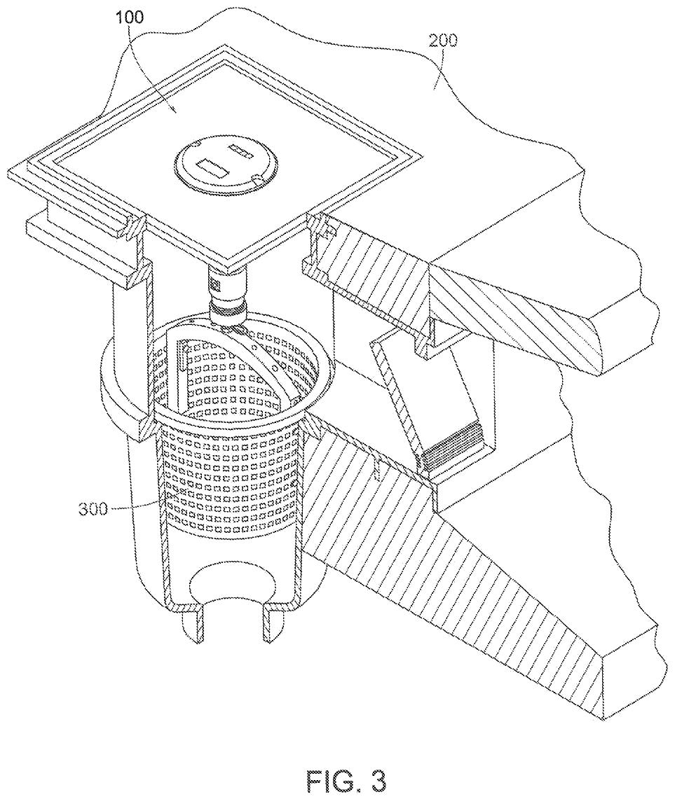

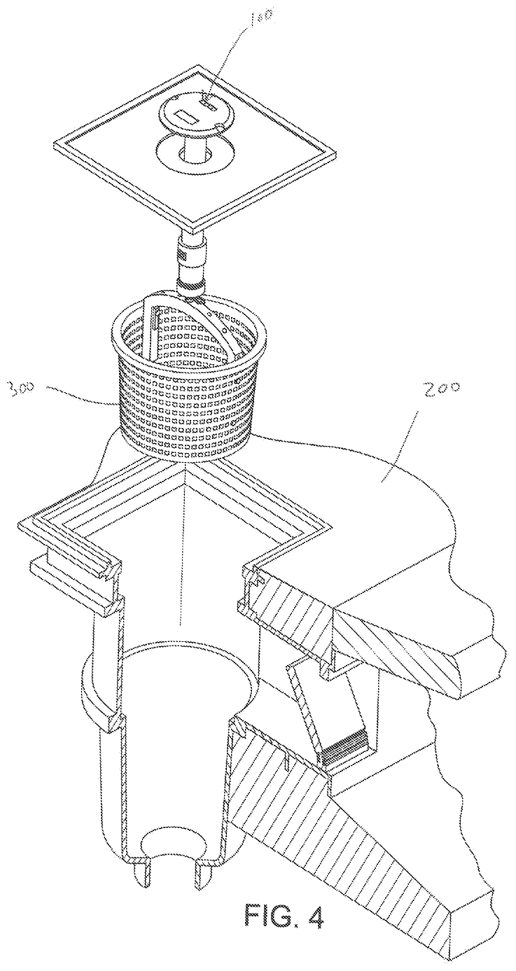

As shown in FIGS. 3 and 4, the pool monitoring apparatus 100 take the place of a traditional skimmer cover in the pool environment. It is preferably that the dimensions of the support plate 102 in conjunction with the surrounding pool deck allow for the support plate 102 to lay substantially flush with the pool deck 200 thereby limiting and/or preventing injury to patrons of the pool. The tubular member 106 may be sized such that a terminal end of the tubular member 106 opposite the support plate 102 resides below a top level of the skimmer basket 300. This allows, as shown in FIG. 4, for the U-shaped member 140 to be easily engaged with the skimmer basket 300 thereby lifting the skimmer basket 300 from the skimmer apparatus to be examined and/or cleaned.

In another embodiment, there is protruding from an end of the tubular member opposite the support plate is the hook and tab structure to assist with lifting a pool skimmer basket from the pool skimmer apparatus. Here, there is at least one and preferably two hooks and a plurality of vacuum tabs. Each of the hooks are sized to assist in engaging and passing at least partially through an opening in the pool skimmer basket. This prevents a user from having to bend down and pull the pool skimmer basket out of the skimmer by hand. The vacuum tabs are disposed along the length of a support structure above the position of the hook(s). The vacuum tabs are small protrusions that engage the skimmer basket to break the vacuum that often holds the basket in the skimmer apparatus. Such tabs greatly increases the ease with which the skimmer basket may be pulled from the skimmer apparatus.

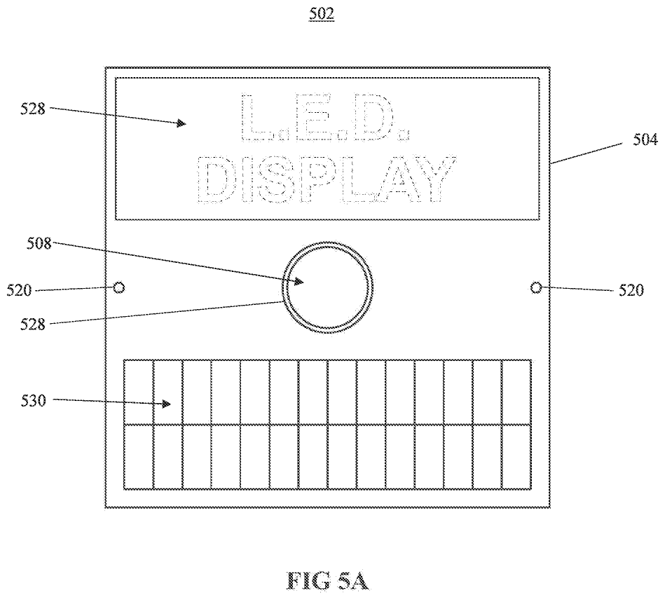

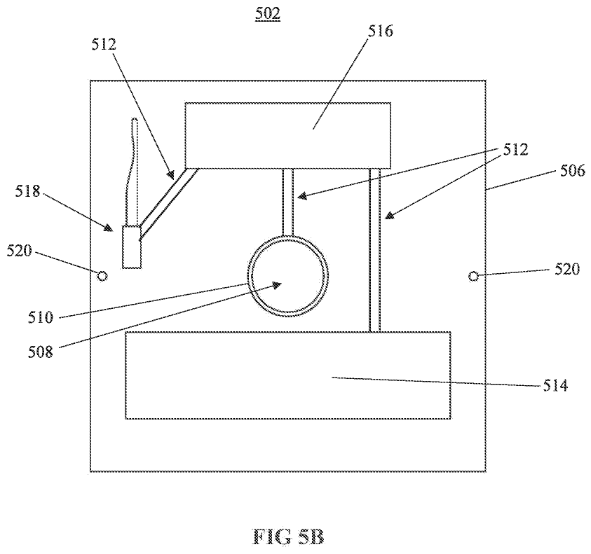

In another embodiment, as shown in FIGS. 5A and 5B the support plate 102 may include a removable information lid 502 with a top 504, a bottom 506, a hole 508. and a metal contact ring 510. In this embodiment, the hole 508 traverses the entire removable information lid 502 from front to back. The metal contact ring 510 is disposed around the edge of the hole 508. In this embodiment, the pool monitoring device 100 may be inserted through the hole 508. The metal contact ring may contact a metal portion of the pool monitoring device 100. In this embodiment, the pool monitoring device 100 may also be an aerator, a chemical dispenser, or other type of pool device.

The top 504 may include a display 528, a solar panel 530. The display 528 may be any type of display (liquid crystal, light emitting diode, etc.) configured to display information associated with the pool monitoring device 100 or the pool itself. The display 528 may be configurable to commonly display certain types of information and may otherwise permit a user to customize or otherwise modify the manner in which information is displayed via the display 528. Information to be displayed may be, for example, information collected by one or more of the sensors associated with the pool monitoring device 100.

The bottom 506 may include several sealed wires 512, a power source 514, a circuit 516, and a communication antenna 518. The sealed wires 512 may connect the metal contact ring 510 to the circuit 516. The sealed wires 512 may also connect the circuit to the power source 514, and connect the circuit 516 to the communication antenna 518.

In one embodiment, the power source 514 may be a rechargeable lithium ion battery. The power source 514 may be coupled to the solar panel 530. The solar panel 530 may be a conventional collection of solar cells configured to utilize light and recharge the power source 514. The power source 514 may be configured to power the circuit 516, the pool monitoring device 100, and the communication antenna 518.

The metal contact ring 510 may be designed to send and receive information from the pool monitoring device 100, and the metal contact ring 510 may be designed to provide power from the power source 514 to the pool monitoring device 100.

The circuit 516 may be designed to control the information displayed on the display 528. The circuit may also be designed to control the function of pool monitoring device 100.

The communication antenna 518 may be any form of wireless communication (WiFi, Bluetooth, NFC, etc.). The communication antenna 518 may be able to send information to a smartphone, or other device. The information sent from the communication antenna 518 may be any information associated with the pool monitoring device 100, the removable information lid 502, or the pool itself. In one embodiment, the communication antenna 518 may also be able to receive information from a smartphone or other device. The information received by the communication antenna 518 may be instructions for the circuit 516. These instructions may include changes to the information displayed on the display 528, and/or information related to the operation of the pool monitoring device 100. In this way, a user may be able to alter the function of the display 528 remotely from a smartphone or other computing device.

The removable information lid 502 may be removably coupled to the support plate 102. In one embodiment the removable information lid further comprises at least one hole 520 designed to receive at least one screw. In this embodiment, the support plate 102 may contain at least one hole 520 designed to receive the at least one screw. The at least one hole 520 of the information lid 502 may be located on the information lid 502 so a center point of the at least one hole 520 lines up with a center point of the at least one hole of the support plate 102. In this embodiment, the at least one screw may be inserted into the at least one hole 520 of the information lid 502, and the at least one hole 520 of the support plate 102, thereby coupling the removable information lid 502 to the support plate 102. It is to be appreciated that although the removable information lid 502 is described as being removably coupled to the support plate 102 with at least one screw, the removable information lid 502 may be removably coupled to the support plate 102 with any structure or method commonly known in the art.

The main components of the pool monitoring device 100 may generally be formed from any suitable material including but not limited to plastics, metals, composites, resins, and the like or any combination thereof. Plastics used in the apparatus may include polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or any combination thereof. Composites may include but are not limited to fiber reinforced plastics, metal composites, carbon fiber, and Kevlar® and the like. Metals may comprise lightweight metals such as aluminum and other pure metals as well as various alloys.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A pool monitoring device comprising:
a support plate;
a tubular member coupled to the support plate;
at least one hook coupled to the tubular member; and
at least one water based sensor configured to sense at least one property of water.

2. The device of claim 1 further comprising a display disposed on the support plate.

3. The device of claim 1 wherein the at least one water-based sensor is a pH sensor, a temperature sensor, or a total dissolved solids sensor.

4. The device of claim 1 further comprising a float slidable coupled to the tubular member.

5. The device of claim 1 further comprising at least one indicator light.

6. The device of claim 1 wherein the tubular member is hollow.

7. A pool monitoring device comprising:
a support plate having a display thereon;
a tubular member having a first end and a second end, the tubular member being coupled to the support plate at the first end;
at least one hook coupled to the second end of the tubular member,
wherein the at least one hook has a plurality of apertures extending through a surface thereof; and
at least one water-based sensor configured to sense at least one property of water.

8. A pool monitoring device comprising:
a support plate having a display thereon,
wherein the support plate has at least one notch along a periphery of the support plate;
a tubular member having a first end and a second end, the tubular member being coupled to the support plate at the first end;
an end cap coupled to the second end of the tubular member;
a U-shaped member coupled to the second end of the tubular member,
at least one water-based sensor configured to sense at least one property of water, wherein the at least one water-based sensor is a pH sensor, total dissolved solids sensor, and a temperature sensor.

9. The device of claim 8 wherein the tubular member is coupled to an underside of the support plate.

10. The device of claim 8 further comprising a float, a first magnet, and a second magnet.

11. The device of claim 10 wherein the float is slidably coupled to the tubular member.

12. The device of claim 10 wherein the first magnet is positioned along a length of the tubular member and the second magnet is positioned along a length of the tubular member.

13. The device of claim 12 wherein the first magnet is positioned above the second magnet.

14. The device of claim 13 wherein the float is positioned between the first magnet and the second magnet.

15. The device of claim 8 further comprising at least one status light emitting diode.

16. The device of claim 15 wherein the at least one status light emitting diode is configured to change color.

17. The device of claim 8 wherein the at least one water-based sensor is configured to generate an alert if data collected by the sensor is outside of a set parameter.

18. The device of claim 10 wherein the first magnet and the second magnet are located at an interior of the tubular member.
